(19) United States
(12) Patent Application Publication
(10) Pub. No.: US 2011/0013860 A1
(43) Pub. Date: Jan. 20, 2011

(54) BEARING

(76) Inventors: Toyoaki Yasui, Hiroshima-shi (JP); Yoshikazu Yamada, Hiroshima-shi (JP); Yuya Konno, Hiroshima-shi (JP); Osamu Isumi, Hiroshima-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/921,516

(22) PCT Filed: Mar. 19, 2009
(86) PCT No.: PCT/JP2009/055426

§ 371 Date: Sep. 8, 2010

(30) Foreign Application Priority Data
Mar. 21, 2008 (JP) 2008 074546

(51) Int. Cl. F16C 17/00

(52) U.S. Cl. 384/26

(57) ABSTRACT

Disclosed is a bearing including: a base consisting of a Cu alloy; an uneven portion formed on the base; a plating layer consisting of a ferromagnetic metal or its alloy and formed on the base so as to cover the uneven portion; and a Sn alloy layer formed on the plating layer. The surface of the Sn alloy layer constitutes a sliding surface against an object that the bearing supports.

### TECHNICAL FIELD

The present invention relates to a bearing with a sliding surface consisting of a Sn alloy layer such as a white metal formed on a base made of a Cu alloy. In the bearing, formation of an inter-metallic compound made with Cu and Sn can be suppressed, and a lifetime of the bearing can be extended.

Priority is claimed on Japanese Patent Application No. 2008-74546 the contents of which are incorporated herein by reference.

### BACKGROUND ART

As is well known, sliding bearings have been widely utilized to support radial and thrust forces of a rotor in rotating machines such as a steam turbine or a centrifugal compressor.

Typically, a sliding bearing is constituted by a base that is made of carbon steel, and a sliding surface made of a Sn alloy layer such as a white metal formed thereon. To improve the heat conductivity as a bearing, a Cu alloy is used as a base instead.

In such bearings where a sliding surface made of a Sn alloy layer is formed on a Cu alloy base, Cu contained in the base and Sn in the Sn alloy layer react when the temperature of the bearing rises to 50 to 60° C. during operation. The reaction causes formation of a columnar inter-metallic compound consisting of Cu—Sn. When an outer force is applied, the Sn alloy layer is easily peeled off from the location where the inter-metallic compound exists.

To avoid this, a method has been disclosed to improve peeling resistance of a bearing having a Cu alloy base and a sliding surface consisting of a Sn alloy layer, by suppressing the formation of the inter-metallic compound consisting of Cu—Sn (refer to Patent document 1 below).

[Patent document 1] Japanese Unexamined Patent Application, First Publication No. H08-135660

### DISCLOSURE OF INVENTION

### Problems to be Solved by the Invention

However, according to the above disclosed method, there is a problem that a number of steps are needed for welding, since Sn plated copper wires, Al wires, Al alloy wires, or the like that are formed in a net structure are needed to be welded to a base to embed those wires inside the Sn alloy layer, to improve the peeling resistance.

The present invention was made to address the problem mentioned above, and it is an object of the present invention to provide a bearing constituted by a base made of a Cu alloy, and a sliding surface made of a Sn alloy layer, wherein the formation of the inter-metallic compound consisting of Cu—Sn is suppressed and the Sn alloy layer is held on the base with a sufficient peeling resistance.

### Means for Solving the Problem

The bearing according to the present invention comprises: a base consisting of a Cu alloy; an uneven portion formed on the base; a plating layer consisting of a ferromagnetic metal or an alloy made of a ferromagnetic metal and formed on the base to cover the uneven portion; and a Sn alloy layer formed on the plating layer, wherein a surface of the Sn alloy layer is a sliding surface against an object that the bearing supports.

According to the bearing of the present invention, when a Sn alloy layer such as of a white metal is formed on a base consisting of a Cu alloy, an uneven portion is formed on a sliding surface of the base, and a plating layer consisting of a ferromagnetic metal or an alloy made of a ferromagnetic metal, such as Ni, Fe, Co, or the like is formed on the base covering the uneven portion, and then the Sn alloy layer is formed onto it.

As a result, contacting of the Sn contained in the sliding surface with the Cu contained in the base is suppressed, resulting in suppressing the formation of a Cu—Sn inter-metallic compound. Moreover, the peeling strength of the Sn alloy layer is improved because the plating layer is held onto the base with sufficient strength by the uneven portion.

In the present invention, the uneven portion means one whose height from the bottom of an indented portion to the top of a bulged portion constituting the uneven portion is smaller than the thickness of the Sn alloy layer. For example, the surface area of an area with a formed uneven portion is 1.5 times or more than that without the uneven portion, which increases a holding force because of the increased contact area with the plating layer.

In a bearing according to the present invention, the uneven portion comprises an indented portion and bulged portion; and a height H from the bottom of the indented groove to the top of the bulged portion may be 0.1 mm or more. Moreover a distance between adjacent bulged portions constituting the uneven portion may be 1.5H or more.

According to the bearing of the present invention, because the height H from the bottom of the indented groove to the top of the bulged portion constituting the uneven portion is 0.1 mm or more, an improved anchor effect is obtained because of the increased contact area. Also because the distance W between adjacent bulged portions constituting the uneven portion is 1.5H or more, and the distance between the top of the bulged portions is increased, shearing of the plating layer from one tip of a bulged portion to another tip of an adjacent bulged portion is difficult to occur.

In a bearing according to the present invention, a thickness t of the plating layer may be 1 μm or more and 300 μm or less. Preferably, the thickness t may be 10 μm or more and 100 μm or less.

According to the bearing of the present invention, plating defects that penetrate through the plating layer are hardly formed because the thickness t of the plating layer is 1 μm or more. Also, since the thickness t of the plating layer is 300 μm or less, reduction of shear strength due to the residual stress in the plating layer is suppressed.

In addition, when the thickness t of the plating layer is 10 μm or more and 100 μm or less, the effect of the increased holding strength of the plating layer due to the bulged portions increases. Therefore the plating layer is easier to be formed stably, and the reaction between the Cu contained in the base and the Sn in the sliding surface is sufficiently suppressed.

In the bearing of the present invention, the uneven portion may include an indented groove that is formed along a direction perpendicular to a sliding direction of the supported object on the sliding surface.

According to the bearing of the present invention, because an indented groove is formed along the direction perpendicular to the sliding direction of the object, relatively stronger shear strength can be obtained with respect to sliding of the object, and thus the peeling off of the Sn alloy layer can be suppressed.

In the bearing of the present invention, bulged portions or indented portions constituting the uneven portion can be interspersed over the base.

According to the bearing of the present invention, because indented portions or bulged portions constituting the uneven portion are interspersed over the base, the effect of the increased contact area increases, and also large shear strength can be ensured without biasing in a particular direction. As a result the peeling off of the Sn layer can effectively be suppressed.

According to the bearing of the present invention, formation of an inter-metallic compound consisting of Cu—Sn is suppressed, and the plating layer and the Sn alloy layer are reliably held on the base. Thus the peeling off of the Sn layer is suppressed, a lifetime of the bearing can be extended, and reliability of the bearing can be improved.

### BRIEF DESCRIPTION OF THE DRAWINGS

FIG. 1 is a perspective view of a bearing according to a first embodiment of the present invention.

FIG. 2 is a plan view of an uneven portion that is formed on a base that constitutes the bearing according to the first embodiment of the present invention.

FIG. 3 is a cross-sectional view showing an indented portion and bulged portions that constitute the uneven portion of the base.

FIG. 4 is a cross-sectional view showing a sliding surface of a bearing that includes the uneven portion formed on the base.

FIG. 5 is a plan view of a bearing according to a second embodiment of the present invention, specifically showing an uneven portion formed on a base that constitutes the bearing.

FIG. 6 is a plan view of a bearing according to a third embodiment of the present invention, specifically showing an uneven portion formed on a base that constitutes the bearing.

FIG. 7 is a plan view of a bearing according to a fourth embodiment of the present invention, specifically showing an uneven portion formed on a base that constitutes the bearing.

FIG. 8 is a perspective view of a bearing according to a fifth embodiment of the present invention, specifically showing a bearing device that includes the bearing.

FIG. 9 is a cross-sectional view that shows a sliding surface of a bearing that includes an uneven portion formed on the base according to the fifth embodiment.

FIG. 10 is a plan view of a bearing according to a sixth embodiment of the present invention, specifically showing an uneven portion formed on a base that constitutes the bearing.

FIG. 11 is a plan view of a bearing according to a seventh embodiment of the present invention, specifically showing an uneven portion formed on a base that constitutes the bearing.

FIG. 12 is a cross-sectional view for describing an example of a bearing according to the present invention showing an indented groove formed on a sample.

FIG. 13 is a graph for describing an effect with regard to a height H of an indented groove in an example of a bearing according to the present invention.

FIG. 14 is a graph for describing an effect with regard to a width W/height H of an indented groove in an example of a bearing according to the present invention.

### BRIEF DESCRIPTION OF THE REFERENCE SYMBOLS

1, 2, 3, 4 Radial bearing (bearing)
5, 6, 7 Sliding bearing (bearing)
10, 30 Sliding surface
11, 21 Base
12 Ni plating layer
13 White metal layer
15, 16, 17, 18, 25, 26, 27 Uneven portion

### BEST MODE FOR CARRYING OUT THE INVENTION

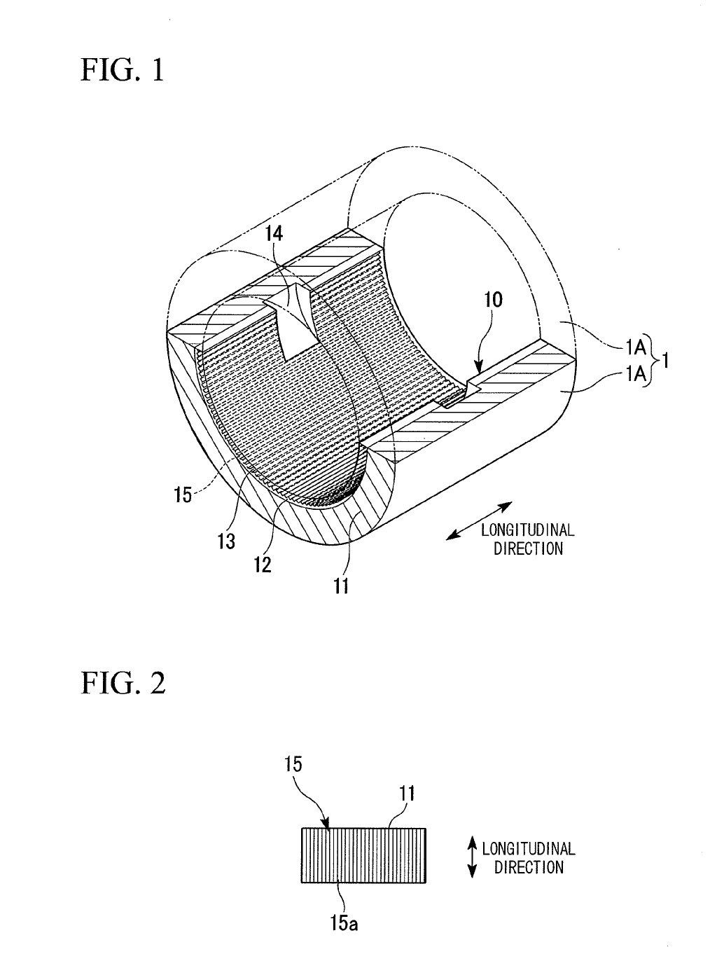

Hereunder, referring to FIG. 1 to FIG. 4, a first embodiment of the present invention will be explained.

As shown in FIG. 1, a bearing 1 is in a cylindrical shape constituted by two segments 1A combined together. It has a predetermined length and its inner and outer circumferences have configuration formed in generally semi-circular shape. The inner circumferential surface of the bearing 1 constitutes a sliding surface 10 that supports a rotation shaft (not shown in the figure) rotating freely.

Each of the segments 1A, which constitutes the bearing 1, includes a base 11, a Ni plating layer 12 that is made of a ferromagnetic metal or a ferromagnetic metal alloy, and a white metal layer 13 as a Sn layer. The Ni plating layer 12 is formed on an inner circumferential surface of the base 11 that corresponds to the sliding surface 10 of the bearing 1, and the white metal layer 13 is formed on the Ni plating layer 12. An uneven portion 15 is formed on the inner circumferential surface of the base 11. An oil groove 14 with a predetermined length in the circumferential direction, is formed on the inner circumferential surface of the base 11 at a substantially central part along the longitudinal direction of the base 11.

The base is made of Cu alloy, and a plurality of indented grooves 15a are formed over the whole area of the inner circumferential surface thereof. As shown in FIG. 2, the indented grooves 15a are formed by using a wheel grindstone tool or the like along the longitudinal direction of the bearing 1, more specifically the axial direction of a rotation shaft (not shown in the figure) supported by the sliding surface 10.

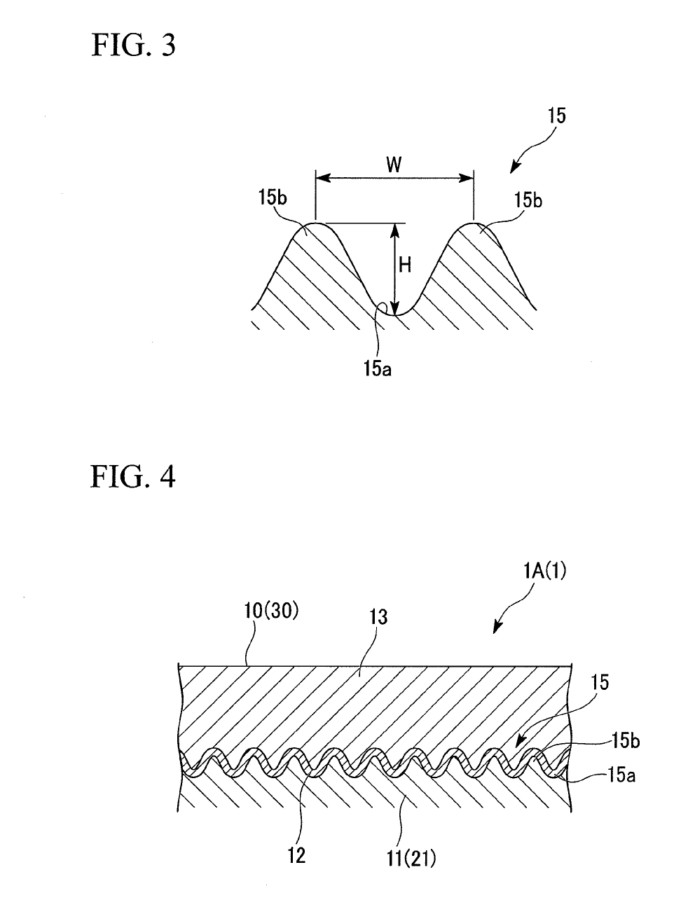

Because of the formation of a plurality of the indented grooves 15a on the inner circumferential surface of the base 11, bulged portions 15b are formed between adjacent indented grooves 15a. Indented grooves 15a and bulged portions 15b are positioned alternately on the inner circumferential surface of the base 11. Because of this, an uneven portion 15 is formed on the inner circumferential surface of the base 11. As shown in FIG. 3, a height H from the bottom of the indented groove 15a to the top of the bulged portion 15b is 0.1 mm or more, and a distance between adjacent bulged portions 15b and 15b, more specifically the groove width W, is 1.5H or more.

In addition, the cross-sectional shape of the indented groove 15a in a plane perpendicular to the longitudinal direction of the bearing 1 can be chosen from, for example, a wave as shown in FIG. 4, a trapezoid, and a rectangle.

The plating layer 12 consists of Ni (nickel) for example, and covers the uneven portion 15 formed on the base 11. The white metal layer 13 is formed on the Ni plating layer 12. A thickness t of the Ni plating layer 12 is preferably 1 μm or more, and 300 μm or less. More preferably, the thickness t is 10 μm or more, and 100 μm or less.

In addition, in regard to the Ni plating, either (1) pure Ni/semi-gloss, (2) pure Ni/gloss, or (3) pure Ni/non-gloss, which are categorized by the status of eutectoid of S (sulfur) component in the additives, can be used. Also a plating consisting of another ferromagnetic metal or ferromagnetic metal alloy, including Ni—Fe plating (Ni-5 to 50 mass % Fe), Ni—W (tungsten) plating (Ni-5 to 50 mass % W), Ni—P (phosphorus) plating (Ni-1 to 15 mass % P), Ni—B plating (Ni-1 to 10 mass % B), or pure Fe plating, or the like, can be used, instead of Ni plating.

In addition, the white metal layer 13 is formed on the surface of the Ni plating layer 12, and the surface thereof forms the sliding surface 10 of the bearing 1. The white metal layer 13 is formed by, for example, being cast onto the base 11 on which the Ni plating layer 12 has been formed.

In addition, the white metal can be chosen from the first (1) and second (JW2) to the tenth class of white metal defined in JIS H 5401. However, other Sn alloy can be used as long as a sufficient sliding property can be obtained.

According to the first embodiment of the present invention, since the Ni plating layer 12 is formed between the base 11 and the white metal layer 13, the formation of a Cu—Sn inter-metallic compound can be suppressed. Also, since the Ni plating layer 12 is held on the base 11 with sufficient strength because of the uneven portion 15, sufficient peeling resistance for the white metal layer 13 can be ensured.

Also, since the thickness t of the Ni plating layer 12 is 1 μm or more, plating defects penetrating through the Ni plating layer 12 are difficult to be formed. Also, since the thickness t is 300 μm or less, reduction of a shear strength, which is caused by a residual stress in the Ni plating layer 12, is suppressed. Also, since the height H from the bottom of the indented groove 15a to the top of the bulged portion 15b is 0.1 mm or more, and the groove width W is 1.5H or more, large shear strength can be ensured. Also, since the indented grooves 15a and the bulged portions 15b that constitute the uneven portion 15 are formed along the direction perpendicular to the sliding direction of the supported object, large shear strength to the acting force by sliding can be ensured, and thus the peeling off of the white metal layer 13 can be suppressed.

As a result, it is possible to extend the lifetime of the bearing, and improve reliability of the bearing.

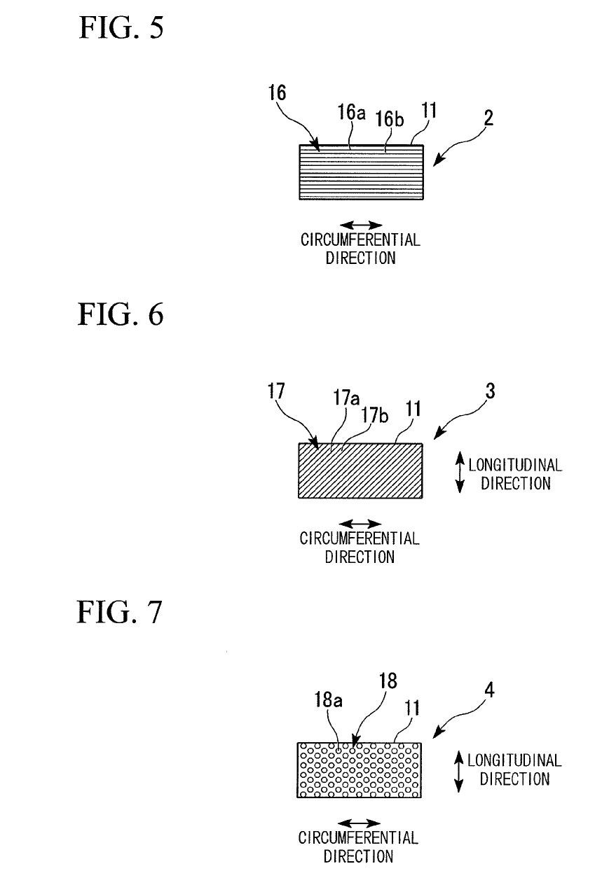

Next, referring to FIG. 5, a second embodiment of a bearing according to the present invention will be explained.

In a bearing 2 according to the second embodiment, a plurality of indented grooves 16a are formed on the inner circumferential surface of the base 11 along the circumferential direction of the bearing 2, more specifically, the sliding direction of a rotation shaft (not shown in the figure), and the bulged portions 16b are formed between adjacent indented grooves 16a. Because of this, an uneven portion 16 according to the present invention is provided on the inner circumferential surface of the base 11. Since other features are similar, explanations are omitted.

According to the bearing 2 of the second embodiment, the indented grooves 16a can be formed while the base 11 is rotated in the circumferential direction when the bearing 2 is fabricated. So, machining is easier and its production cost can be reduced. In addition, it is possible to provide a bearing 2 in which an acting force on the sliding surface thereof is small, at low cost.

Next, referring to FIG. 6, a third embodiment of a bearing according to the present invention will be explained.

In a bearing 3 of the third embodiment, a plurality of indented grooves 17a are formed on the inner circumferential surface of the base 11 along a direction that traverses both of the circumferential direction and the longitudinal direction of the bearing 3, that is, along a direction that traverses the longitudinal direction diagonally, and bulged portions 17b are formed between adjacent indented grooves 17a. Because of this, an uneven portion 17 according to the present invention is provided on the inner circumferential surface of the base 11. Since other features are similar, explanations are omitted.

According to the bearing 3 of the third embodiment, because large shear strength can be ensured to the load acting in both radial and thrust directions, the bearing can be effectively used as one that can bear loads in both radial and thrust directions. Also, in the same way to the bearing 2 of the second embodiment, its production cost can be reduced.

Next, referring to FIG. 7, a fourth embodiment of the present invention will be explained.

In a bearing 4 of the fourth embodiment, a plurality of bulged portions 18a are interspersed over the inner circumferential surface of the base 11 with substantially the same spacing from each other. Because of this, an uneven portion 18 according to the present invention is provided on the inner circumferential surface of the base 11. Since other features are similar, explanations are omitted.

The bulged portions 18a can be formed by, for example, shot blasting, or by molding, or the like, using a mold. In addition, not only a configuration where a plurality of bulged portions 18a are formed on the inner circumferential surface of the base 11 as shown in FIG. 7 to form the uneven portion 18 on the inner circumferential surface of the base 11, but also a configuration where a plurality of indented portions are formed on the inner circumferential surface of the base 11 to form the uneven portion 18 on the inner circumferential surface of the base 11, may be adopted. Moreover, a configuration where both of the above configurations are combined can be adopted.

According to the bearing 4 of the fourth embodiment, because the uneven portion is provided on the inner circumferential surface of the base 11, a larger contact area with the Ni plating layer 12 can be ensured. In addition, since the array of the bulged portions 18a does not have directionality, a large shear strength can be ensured on the uneven portion 18 to the forces acting in both radial and thrust directions.

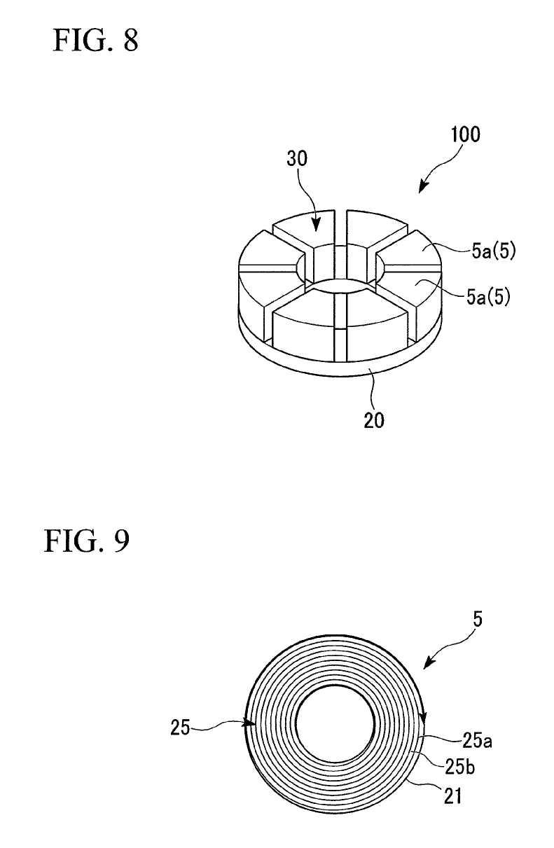

Next, referring to FIG. 8 and FIG. 9, a fifth embodiment of the present invention will be explained.

A bearing device 100 is shown in FIG. 8 that utilizes a bearing 5 (or bearing 6, 7) described below. In the bearing device 100, the bearing 5 is constituted by, for example, eight segments along the circumferential direction divided by lines that run across the axis. Each segment 5a is fixed to a disc 20 that constitutes the bearing device 100. The bearing device 100 constitutes a thrust bearing that receives thrust force generated in a rotation shaft. In addition, whether the bearing 5 should or should not be divided into segments or how many it should be, is optional.

The bearing 5 includes a base 21 that is constituted by Cu alloy and has a flat disc shape. At the center part of the base 21, a circular hole is formed. Similar to the first embodiment shown in FIG. 4, a Ni plating layer 12 is formed on the surface of the base 21, and a white metal layer 13 is formed on the Ni plating layer 12.

In FIG. 9, an uneven portion 25, which is formed on the base 21 and constituting of the bearing 5, is shown. Over the whole surface of one side face of the base 21, an indented groove 25a is formed in a coil shape, gradually increasing its radius from its inner periphery to outer periphery, and revolving circumferentially. A bulged portion 25b is formed between parts of the groove 25a that are adjacent to each other in the radial direction. Because of this, an uneven portion 25 of the present invention is provided on the side face of the base 21. As the Ni plating layer 12 and the white metal (Sn alloy) layer 13 are similar to the bearing 1, their explanations are omitted. In addition, the bearing 5 can be divided into segments as shown in FIG. 8 and be fixed onto the disc 20, or can be used without being divided.

According to the bearing 5 of the fifth embodiment, since the indented groove 25a is formed along the direction in which the sliding force acts, it is possible to ensure a large shear strength to a thrust force, to suppress peeling off of the white metal layer 13, to extend the lifetime of the bearing 6, and to improve reliability of the bearing 6.

Moreover, since the indented groove 25a is formed in a coil shape, it can be easily fabricated by a lathe for instance.

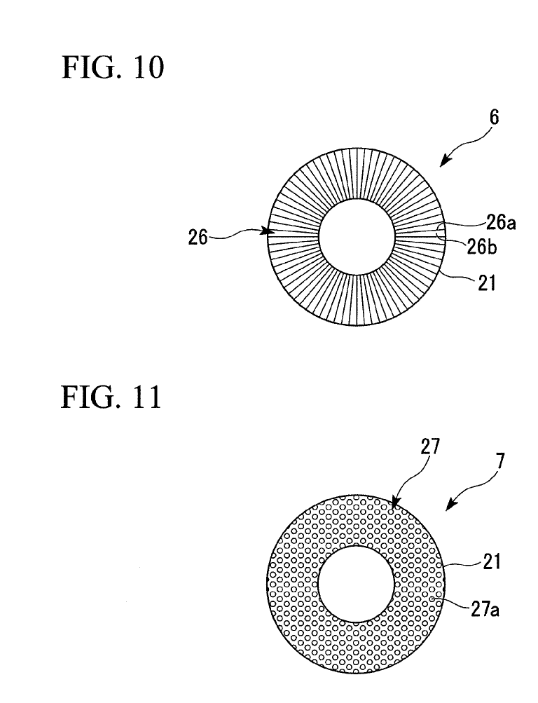

Next, referring to FIG. 10, a sixth embodiment of the present invention will be explained.

In FIG. 10, an uneven portion 26, which is formed on the base 21 that constitutes a bearing 6, is shown. In this embodiment, a plurality of indented grooves 26a that extend radially towards the outmost circumference of the base 21, are formed on one side face of the base 21, and bulged portions 26b are formed between the indented grooves 26a that are adjacent to each other in the circumferential direction. Because of this, the uneven portion 26 of the present invention is provided on the side face of the base 21. Since other features are similar to the bearing 5, explanations are omitted. In addition, the bearing 6 can be divided into segments and be fixed onto the disc 20, similar to the bearing 5 of the fifth embodiment, or can be used without being divided.

According to the bearing 6 of the sixth embodiment, since the indented groove 26a is formed in the direction that is perpendicular to the direction in which the sliding force acts, it is possible to ensure a large shear strength, to suppress peeling off of the white metal layer 13, to extend a lifetime of the bearing 6, and to improve reliability of the bearing 6.

Next, referring to FIG. 11, a seventh embodiment of the present invention will be explained.

In FIG. 11, an uneven portion 27 which is formed on the base 21 of a bearing 7, is shown. On one side face of the base 21, a plurality of bulged portions 27a are scattered with substantially the same distance between each other. Because of this, the uneven portion 27 of the present invention is provided on the side face of the base 21. Since other features are similar to the bearing 5, explanations are omitted. In addition, the bearing 7 can be divided into segments and be fixed onto the disc 20, similar to the bearing 5 of the fifth embodiment, or can be used without being divided.

The bulged portions 27a can be formed by, for example, shot blasting, or by molding or the like using a mold, similar to the bulged portion 18a of the fourth embodiment. In addition, not only a configuration where a plurality of bulged portions 27a are formed on the base 21 to provide an uneven portion 27 on the side face the base 21, but also a configuration where plurality of indented portions are formed on the base 21 to provide an uneven portion 27 on the side face the base 21, may be adopted. Moreover, a configuration where both of the above configurations are combined can be adopted.

According to the bearing 7 of the seventh embodiment, because the uneven portion is provided on one side face of the base 21, a larger contact area with the Ni plating layer 12 can be ensured. Moreover, since the array of the bulged portions 27a does not have directionality, a large shear strength can be ensured on the bulged portions 27a, to the forces acting in both radial and thrust directions. As a result, it is possible to suppress peeling off of the white metal layer 13, to extend a lifetime of the bearing 7, and to improve reliability of the bearing 7.

### Example

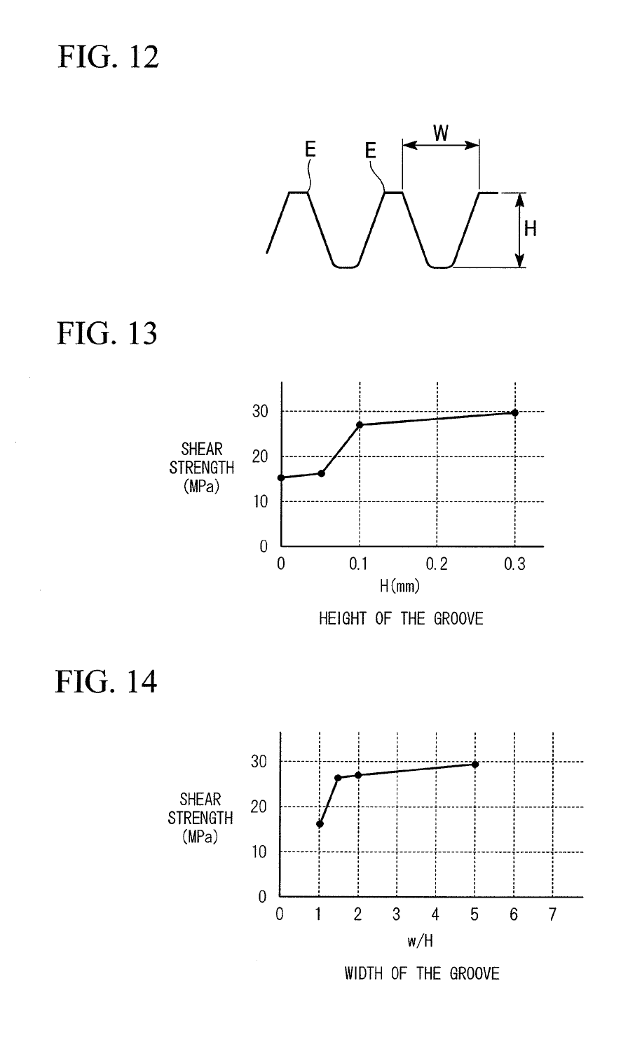

Next, referring to FIG. 12 to FIG. 14, how the uneven portions provided on the bases effect the shear strength will be explained.

A sample was prepared by forming indented grooves on Cr (Cu alloy containing chromium), forming a Ni plating layer of 20 μm in thickness to cover the grooves, and forming a white metal (JW2) layer after the formation of the plating layer. The sample was then heated to 120° C. After keeping it for 225 hours at 120° C., it was cooled down to 160° C. and kept for 100 hours at 160° C. The shear strength was then measured according to JISG0601 (2002).

In addition, the indented grooves have a shape where the bulged portions that form the indented grooves have a trapezoidal shape as shown in FIG. 12.

FIG. 13 shows a relationship between the height H (mm) from the bottom of the indented groove to the top of the bulged portion, and shear strength (MPa). It was confirmed that the shear strength was significantly improved when the height H is 0.1 (mm) or more. When the height H is less than 0.1 (mm), fracture due to shearing between corners E of bulged portions, which were formed on both sides across the indented groove, easily occurred.

FIG. 14 shows a relationship between W/H (the width/height of the groove) and shear strength (MPa). It was confirmed that the shear strength was significantly improved when W/H is 1.5 or more. When W/H is less than 1.5, fracture due to shearing between corners E of two bulged portions, which were formed on both sides across the indented groove, easily occurred.

Accordingly, it is confirmed that it is advantageous to have the height H≧0.1 mm and the groove width W≧1.5H.

In addition, the present invention is not limited to the above embodiments, and various modifications within the scope of the present invention are possible.

For example, although in the above example the height H from the bottom of the indented groove to the top of a bulged portion is 0.1 mm or more, and the distance between adjacent bulged portions, or the indented groove width W is 1.5H or more is explained, it is obvious that any one of the above conditions or both conditions do not have to be met.

In addition, although the above embodiments describe that a Ni plating layer is formed on a base, and the thickness of the plating layer is between 1 μm and 300 μm inclusive, an alloy other than a Ni alloy, or a metal other than Ni, can be used to form a plating layer instead. Also the thickness of a plating layer can be less than 1 μm or can be more than 300 μm.

In addition, although the uneven portions are provided by, either forming a plurality of indented grooves on the surface of the base, or forming a plurality of bulged portions on the surface of the base, in the above embodiments, the uneven portion with other configurations can be formed on the bases.

Also, in the above embodiments, the uneven portion is formed on the whole area of the inner surface or one side face of the base 1 that corresponds to the sliding surface of the bearing 1. However, an uneven portion can be formed on only a part of a bearing where a sliding force acts more frequently and tends to be a starting point of peeling off, such as end parts in the sliding direction of the bearing.

Also, in the above embodiments, the uneven portions are formed by machining or the like. However, physical processing such as electron beam, or chemical processing such as etching can be utilized to form the uneven portions.

1. A bearing comprising:
a base consisting of a Cu alloy;
an uneven portion formed on the base;
a plating layer consisting of a ferromagnetic metal or an alloy made of a ferromagnetic metal and formed on the base to cover the uneven portion; and
a Sn alloy layer formed on the plating layer,
wherein a surface of the Sn alloy layer is a sliding surface against an object that the bearing supports.

2. A bearing according to claim 1, wherein the uneven portion comprises an indented portion and bulged portion; and
a height H from a bottom of the indented portion to a top of the bulged portion is 0.1 mm or more.

3. A bearing according to claim 1, wherein a distance W between adjacent bulged portions constituting the uneven portion is 1.5H or more.

4. A bearing according to claim 1, wherein a thickness t of the plating layer is 1 μm or more and 300 μm or less.

5. A bearing according to claim 4, wherein the thickness t of the plating layer is 10 μm or more and 100 μm or less.

6. A bearing according to claim 1, wherein the uneven portion includes an indented groove that is formed along a direction perpendicular to a sliding direction of the supported object on the sliding surface.

7. A bearing according to claim 1, wherein bulged portions or indented portions constituting the uneven portion are interspersed over the base.

8. A bearing according to claim 2, wherein a distance W between adjacent bulged portions constituting the uneven portion is 1.5H or more.

9. A bearing according to claim 2, wherein a thickness t of the plating layer is 1 μm or more and 300 μm or less.

10. A bearing according to claim 9, wherein the thickness t of the plating layer is 10 μm or more and 100 μm or less.

11. A bearing according to claim 2, wherein the uneven portion includes an indented groove that is formed along a direction perpendicular to a sliding direction of the supported object on the sliding surface.

12. A bearing according to claim 2, wherein bulged portions or indented portions constituting the uneven portion are interspersed over the base.

13. A bearing according to claim 3, wherein a thickness t of the plating layer is 1 μm or more and 300 μm or less.

14. A bearing according to claim 13, wherein the thickness t of the plating layer is 10 μm or more and 100 μm or less.

15. A bearing according to claim 3, wherein the uneven portion includes an indented groove that is formed along a direction perpendicular to a sliding direction of the supported object on the sliding surface.

16. A bearing according to claim 3, wherein bulged portions or indented portions constituting the uneven portion are interspersed over the base.

17. A bearing according to claim 5, wherein the uneven portion includes an indented groove that is formed along a direction perpendicular to a sliding direction of the supported object on the sliding surface.

18. A bearing according to claim 5, wherein bulged portions or indented portions constituting the uneven portion are interspersed over the base.

19. A bearing according to claim 4, wherein the uneven portion includes an indented groove that is formed along a direction perpendicular to a sliding direction of the supported object on the sliding surface.

20. A bearing according to claim 4, wherein bulged portions or indented portions constituting the uneven portion are interspersed over the base.
